(19) United States
(12) Patent Application Publication
(10) Pub. No.: US 2019/0281024 A1
(43) Pub. Date: Sep. 12, 2019

(54) COMMUNICATION METHOD, SYSTEM, AND DATA PROCESSING METHOD

(71) Applicant: Alibaba Group Holding Limited, Grand Cayman (KY)

(72) Inventors: Yongliang Liu, Beijing (CN); Jieqian Zheng, Hangzhou (CN); Wei Huang, Beijing (CN)

(73) Assignee: Alibaba Group Holding Limited

(21) Appl. No.: 16/256,997

(22) Filed: Jan. 24, 2019

(30) Foreign Application Priority Data
Mar. 9, 2018 (CN) 201810195656.1

(51) Int. Cl. H04L 29/06; H04L 29/08

(52) U.S. Cl. CPC H04L 63/0428; G06K 7/1417; H04L 63/123; H04L 67/20

(57) ABSTRACT

A communication method, system, and a data processing method are provided. The system includes the following. A first client terminal is configured to generate a carrier object carrying hidden information. A second client terminal is configured to receive the carrier object from the first client terminal and parse the carrier object to obtain relevant information of the hidden information and obtain valid identification information according to feedback information fed back by a third client terminal. The third client terminal is configured to receive the relevant information from the second client terminal and send the feedback information to the second client terminal according to the relevant information.

### CROSS REFERENCE TO RELATED PATENT APPLICATIONS

This application claims priority to Chinese Patent Application No. 201810195656.1, filed on 9 Mar. 2018, entitled “COMMUNICATION METHOD, SYSTEM, AND DATA PROCESSING METHOD” which is hereby incorporated by reference in its entirety.

### TECHNICAL FIELD

The present disclosure relates to the field of communication technologies, and in particular, to communication methods and systems, and data processing methods.

### BACKGROUND

In communication-related fields, product information, such as promotion and discount information of products, may be embedded in a carrier, such as an image object, in a visible or invisible manner to facilitate the dissemination of product-related information among a wider audience.

However, the conventional techniques have not yet provided an effective solution to the technical problem of ensuring the security and reliability of the transmission of hidden information.

### SUMMARY

This Summary is provided to introduce a selection of concepts in a simplified form that is further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

Example embodiments of the present disclosure provide a communication method and system, and a data processing method, to at least solve the technical problem that it is still difficult for the existing communication solution to guarantee the security and reliability of the transmission of hidden information.

According to an example embodiment of the present disclosure, a communication system is provided, including the following. A first client terminal is configured to generate a carrier object carrying hidden information. A second client terminal is configured to receive the above carrier object from the first client terminal and parse the above carrier object to obtain the relevant information of the above hidden information and obtain valid identification information according to the feedback information fed back by a third client terminal. The above third client terminal is configured to receive the above relevant information from the second and send the above feedback information to the above second client terminal according to the above relevant information.

According to an example embodiment of the present disclosure, a communication system is provided, including a first device and a second device. The above first device runs the first and the second application. The above second device runs the third application and the fourth application. The above first application is configured to generate a carrier object carrying hidden information. The above second application is configured to issue the above carrier object. The above third application is configured to obtain the above carrier object issued by the above second application and obtain valid identification information according to the feedback information fed back by the above fourth application. The fourth application is configured to obtain the above carrier object from the above third application and parse the above carrier object when the preset trigger event is detected, to obtain the above hidden information.

According to an example embodiment of the present disclosure, a communication method is provided, including the following. A first client terminal receives a carrier object from a second client terminal, where the carrier object carries the hidden information. The above first client terminal parses the above carrier object to obtain the relevant information of the above hidden information. The above first client terminal sends the above relevant information to the third client terminal. The above first client terminal receives feedback information from the above third client terminal and determines valid identification information according to the above feedback information, wherein the above feedback information is information fed back according to the above relevant information.

According to the example embodiments of the present disclosure, a communication method is provided, including the following. The fourth application detects a preset trigger event. When the fourth application detects the above preset trigger event, the fourth application obtains the carrier object from the third preset application, where the carrier object carries the hidden information. The above third application obtains the above carrier object from the content issued by the second application, where the above carrier object is the carrier object generated by the first application. The above fourth application parses the above carrier object to obtain the above hidden information.

According to an example embodiment of the present disclosure, a storage medium is further provided, including a stored program, wherein a device in which the storage medium is located performs the following functions when the program is executed. The first client terminal receives the carrier object from the second client terminal, where the carrier object carries the hidden information. The above first client terminal parses the above carrier object to obtain the relevant information of the above hidden information. The above first client terminal sends the above relevant information to the third client terminal. The above first client terminal receives feedback information from the above third client terminal and determines valid identification information according to the above feedback information, where the above feedback information is information fed back according to the above relevant information.

According to an example embodiment of the present disclosure, a processor is further provided, the processor being configured to execute a program, wherein the above program performs the following functions when executed. The first client terminal receives the carrier object from the second client terminal, where the carrier object carries the hidden information. The above first client terminal parses the above carrier object to obtain the relevant information of the above hidden information. The above first client terminal sends the above relevant information to the third client terminal. The above first client terminal receives feedback information from the above third client terminal and determines valid identification information according to the above feedback information, where the above feedback information is information fed back according to the above relevant information.

According to the present disclosure, a data processing method is further provided, including the following. A preset trigger event is detected, where the above preset trigger event includes a save operation on the target data performed by the target application. The above target data is obtained, where the target data includes hidden information. The above hidden information is obtained from the above target data, where the above hidden information includes a target access address or product description information.

According to an aspect of the example embodiments of the present disclosure, a data processing method is provided, including the following. A preset trigger event is detected, where the above preset trigger event includes an open operation on the target data performed by the target application. The above target data is obtained, where the target data includes hidden information. The above hidden information is obtained from the above target data, where the above hidden information includes a target access address or product description information.

In the example embodiments of the present disclosure, the first client terminal is configured to generate a carrier object carrying the hidden information. The second client terminal is configured to receive the above carrier object from the first client terminal and parse the above carrier object to obtain the relevant Information of the above hidden information and obtain valid identification information based on the feedback information fed back from the third client terminal. The above third client terminal is configured to receive the above relevant information from the above second client terminal and send the above feedback information to the above second client terminal according to the above relevant information. The transmission of the hidden information does not attract the attention and concern of the third party. The purpose of ensuring the secure and reliable transmission of the hidden information is guaranteed, thereby achieving the technical effect that the possibility of the transmitted hidden information being attacked by the third party is reduced. As such, the technical problem that it is still difficult for the existing communication solution to guarantee the security and reliability of the transmission of the hidden information is solved.

### BRIEF DESCRIPTION OF THE DRAWINGS

In order to illustrate the example embodiments of the present disclosure or the technical solutions in the conventional techniques more clearly, the drawings used in the description of the example embodiments will be briefly introduced below. Apparently, the drawings in the following description represent some of the example embodiments of the present disclosure, and other drawings may be obtained from these drawings by those skilled in the art without any creative work.

The drawings described herein are used to provide a further understanding of the disclosure and constitute a part of this application. The illustrative example embodiments of the present disclosure and the description thereof are intended to explain the present disclosure and are not intended to limit the disclosure. In the drawing:

FIG. 1 is a schematic structural diagram of a communication system according to an example embodiment of the present application;

FIG. 2 is a schematic structural diagram of another communication system according to an example embodiment of the present application;

FIG. 3 is a schematic diagram of an interaction process in a communication system according to an example embodiment of the present application;

FIG. 4 is a hardware structural block diagram of a computer terminal (or mobile device) for implementing a communication method according to an example embodiment of the present application;

FIG. 5 is a flowchart of a communication method according to an example embodiment of the present disclosure;

FIG. 6 is a flowchart of another communication method according to an example embodiment of the present disclosure;

FIG. 7 is a schematic structural diagram of a communication apparatus according to an example embodiment of the present disclosure;

FIG. 8 is a schematic structural diagram of another communication apparatus according to an example embodiment of the present disclosure;

FIG. 9 is a flowchart of a data processing method according to an example embodiment of the present disclosure;

FIG. 10 is a flowchart of another data processing method according to an example embodiment of the present disclosure;

FIG. 11 is a schematic structural diagram of a data processing apparatus according to an example embodiment of the present disclosure; and

FIG. 12 is a schematic structural diagram of another data processing apparatus according to an example embodiment of the present disclosure.

### DETAILED DESCRIPTION

To enable a person of ordinary skill in the art to better understand the solutions of the present disclosure, hereinafter, technical solutions in the example embodiments of the present disclosure will be clearly and completely described with reference to the accompanying drawings in the example embodiments of the present disclosure. Example embodiments described above merely represent some of the example embodiments of the disclosure. Other example embodiments obtained by a person of ordinary skill in the art based on the example embodiments of the present disclosure without making creative efforts should fall within the scope of the present disclosure.

It should be noted that the terms “first”, “second”, and the like in the specification and claims of the present disclosure are used to distinguish similar objects, but are not necessarily used to describe a particular order. It is to be understood that the data so used is interchangeable, where appropriate, so that the example embodiments of the disclosure described herein can be implemented in a sequence other than those illustrated or described herein. In addition, the terms “comprise”, “have”, and any variants thereof are intended to cover a non-exclusive inclusion. For example, a process, a method, a system, a product, or a device that comprises a series of steps or units is not necessarily limited to those steps or units but may include other steps or units inherent to such processes, methods, products or devices without being explicitly listed.

First, some of the nouns or terms that appear during describing the example embodiments of the present application are applicable to the following explanations:

Carrier object refers to a carrier of matter, message (information), culture, etc. The carrier in this application is not limited to the meaning in fields such as transportation, military, chemical, biological, and the like. The carrier object may also refer to the concept of factors that constitute the things in a broad sense, i.e., the existence form of the matter factor. The individual formed by the object is the carrier of the thing. For example, the digitized host information may also be a carrier object. The carrier object in the example embodiment of the present application may include, but not limited to, a picture, a video image, and the like.

Information hiding, which is also known as data hiding, is an emerging technology field that combines multidisciplinary theories and technologies. Information hiding technology mainly refers to the embedding of information into digital host information such as text, digitized sound, images, video signals, and the like. The purpose of information hiding is not to limit the correct information storing, reading, and accessing, but to ensure that the hidden information does not attract the attention and concern of the monitor, thereby reducing the possibility of being attacked. The information hiding may include hidden technology, visual cryptography technology, and watermarking technology. The information hiding in this application may be the hidden technology. That is, the secret information is embedded in the information that looks ordinary to be sent to prevent the third party from detecting the secret information. The particular information processed by the information hiding method may be regarded as hidden information.

### Embodiment 1

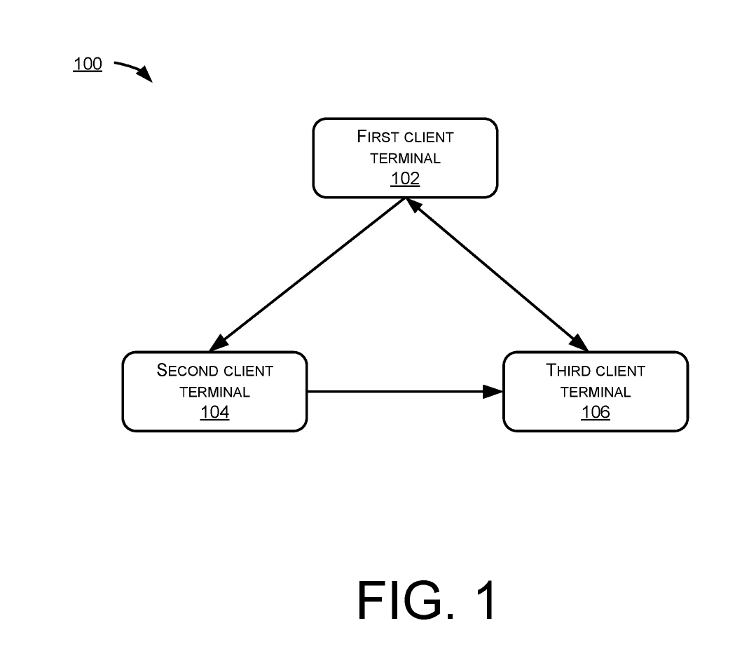

Prior to describing further details of various example embodiments of the present application, a suitable communication system example embodiment that can be used to implement the principles of the present application will be described with reference to FIG. 1.

FIG. 1 is a schematic structural diagram of a communication system 100 according to an example embodiment of the present application. For the purposes of description, the depicted structure is only an example of a suitable environment and is not intended to limit the scope of the application, nor should the communication system be interpreted as having any dependency or requirement on any of the components or combinations thereof shown in FIG. 1.

According to an example embodiment of the present application, a communication system 100 is provided. As shown in FIG. 1, the communication system 100 includes a first client terminal 102, a second client terminal 104, and a third client terminal 106.

It should be noted that the communication system provided by the present application may be, but is not limited to, a communication solution involving three client terminals. The above first client terminal 102 is a sender. The above second client terminal 104 is a receiver. The above third client terminal 106 is a third-party application. The above first client terminal 102 (the sender) may embed the communication information that needs to be kept secret into the carrier object in a manner of information hiding. The above second client terminal 104 (the receiver) may extract the hidden information embedded in the carrier object and obtain the valid identification information by means of the feedback information fed back by the third client terminal 106 (the third party).

In an example embodiment, the above first client terminal 102, the above second client terminal 104, and the above third client terminal 106 are applications running on the same device or different devices. The device may be, but is not limited to, a mobile terminal device and a computer terminal device.

The first client terminal 102 is configured to generate a carrier object carrying hidden information.

In an example embodiment, the above first client terminal may be any shopping types of client terminal, for example, Suning, Jingdong, Vipshop, and the like. The above carrier object may be an image, a text document, a web page, video, audio, and the like. The above hidden information may be presented in the form of a barcode, a two-dimensional code, or the like. The above hidden information may be, but is not limited to, a product promotion or discount information, for example, a scan code for receiving a red pocket, a scan code for immediate discount, and the like.

In addition, the above hidden information may also be information associated with the carrier object, such as signature information of the carrier object or description information of the carrier object. The carrier object carrying the hidden information is generated by the first client terminal (the sender), so that the second client terminal (the receiver) may use and manage the received carrier object.

In an example embodiment, the above first client terminal 102 may, but is not limited to, generate a carrier object carrying the hidden information by an information embedding algorithm in an information hiding manner.

It should be noted that the above hidden information may be from the first client terminal 102. For example, the above first client terminal 102 generates the above hidden information according to the request data of the target object. In an example embodiment, the above first client terminal 102 is further configured to obtain the above hidden information in the following manner, i.e., the above first client terminal 102 receives the original information of the above hidden information from the above third client terminal 106, and performs information hiding processing on the above original information to obtain the above hidden information.

For example, the above carrier object which is an image. In the example embodiment of the present application, the above hidden information may be carried, but not limited to, in the following manners, i.e., embedding barcode information in any area in the image, embedding barcode information at the edge of the image, embedding two-dimensional code information in any area in the image, and embedding the two-dimensional code information at the edge of the image.

In the above example embodiment, the method of embedding hidden information into the carrier object and distributing the hidden information together with the carrier object has at least the following technical effects. If there is a close correlation between the above hidden information and the above carrier object, for example, the carrier object is a product image, and the above hidden information is promotion or price comparison-relevant information (such as a URL link) of the product, the above distribution method not only has the characteristics of convenient distribution and convenient management, but also makes the communication solution provided by the present application more widely applicable by using the feedback of the third party, further ensuring accurate and effective dissemination of the above hidden message.

The second client terminal 104 is configured to receive the above carrier object from the first client terminal, and parse the above carrier object to obtain information about the above hidden information, and obtain valid identification information according to feedback information fed back by the third client terminal.

In an example embodiment, the above second client terminal 104 may be a communication application, for example, any type of instant messaging software such as WeChat and QQ.

To understand the communication system provided by the present application, hereinafter, an example embodiment of the present application is described through an example communication solution:

The above first client terminal 102 embeds the message M to be sent or distributed into the carrier object in an information hiding manner, generates a carrier object CR carrying the hidden information M, and distributes the carrier object CR containing the hidden information M. The above second client terminal 104 receives the carrier object CR from the first client terminal and parses the above carrier object to obtain relevant information of the above hidden information M. For example, the above second client terminal 104 may extract the message M carried by the above carrier object from the carrier object CR, and may also extract relevant information of the above hidden information from the carrier object CR.

It should be noted that the above relevant information may or may not be consistent with the above hidden information, and the above relevant information may include but is not limited to one hidden message or multiple hidden messages.

It should be noted that the carrier object CR received by the above second client terminal 104 may be identical to the carrier object CR sent by the above first client terminal 102, or with more or less difference. The above difference may be caused by distortion during transmission or malicious modification.

The third client terminal 106 is configured to receive the above relevant information from the above second client terminal and send the above feedback information to the above second client terminal according to the above relevant information.

In an example embodiment, the above third client terminal 106 may be, but is not limited to, a server, such as a cloud server. The above third client terminal 106 may, but not limited to, send the above feedback information to the above second client terminal according to the above relevant information by an information extraction algorithm.

In an example embodiment, the example embodiment of the present application is also described by the above example communication solution:

The above second client terminal 104 receives and parses the above carrier object CR to obtain the relevant information of the hidden information M, and sends the above relevant information related about the hidden information M to the third client terminal 106. After receiving the above relevant information of the hidden information M, the third client terminal 106 may process the above relevant information to obtain feedback information, and then send the above feedback information to the above second client terminal 104 according to the above relevant information. After receiving the above feedback information FM of the above third client terminal, the second client terminal 104 may determine whether to perform subsequent operations according to the feedback information FM, for example, to stop performing subsequent operations, or to perform necessary subsequent operations.

In the above example embodiment, if the above feedback information FM is a feedback information containing error information, the second client terminal 104 stops performing subsequent operations, and the entire communication process ends. If the above feedback information FM is a valid feedback message, the second client terminal 104 performs further operations based on the feedback message M. Further, the second client terminal 104 may obtain the valid identification information according to the feedback information fed back by the third client terminal.

It should be noted that during the entire communication process, the second client terminal 104 may not have the ability to independently process the relevant information of the hidden information M. Therefore, the above second client terminal 104 requires assistance and feedback from the third client terminal 106 to complete the communication.

In an example embodiment, for example, the above carrier object is a product image and the above hidden information is two-dimensional code information QR. The above first client terminal 102 may embed the two-dimensional code information QR associated with the above product into the product image in a visible or invisible manner to obtain a product image IQR carrying the above two-dimensional code information QR.

The above first client terminal 102 sends the product image IQR carrying the above two-dimensional code information QR to the second client terminal 104. The second client terminal 104 receives and parses the above product image IQR and extracts the two-dimensional code information QR or the relevant information related about the two-dimensional code information QR from the product image IQR, and send the two-dimensional code information QR or the relevant information about the two-dimensional code information QR to the third client terminal 106. After receiving the related message sent by the second client terminal 104, the third client terminal 106 may process the above relevant information to obtain the feedback information FM, and then send the above feedback information FM to the second client terminal 104 according to the above relevant information. After receiving the feedback information FM from the above third client terminal, the second client terminal 104 may determine whether to perform subsequent operations according to the feedback information FM, for example, to stop performing subsequent operations, or to perform necessary subsequent operations.

It should be noted that, in the example embodiment provided by the present application, if the above second client terminal 104 cannot effectively parse the two-dimensional code information QR, the above third client terminal 106 may also assist the second client terminal 104 to parse the two-dimensional code information QR. If the above second client terminal 104 can effectively parse the two-dimensional code information QR, the above third client terminal 106 may also assist the above second client terminal 104 to confirm the correctness of the two-dimensional code information QR extracted from the product image IQR (or the relevant information about the two-dimensional code information QR). Alternatively, to ensure accurate and effective propagation of the above hidden message, the second client terminal 104 may perform further operations only after the above third client terminal 106 sends the above feedback information to the above second client terminal according to the above relevant information.

In an example embodiment, for example, the above hidden information is signature information. The first client terminal 102 may embed a signature message into the carrier object to obtain a carrier object carrying the above signature message. The above signature message may be, but is not limited to, a signature on the carrier object. The signature information of the carrier object is embedded in the carrier object, so that the second client terminal 104 (the receiver) may verify the signature information.

The first client terminal 102 sends the carrier object information carrying the above signature information to the second client terminal 104. After receiving the carrier object, the second client terminal 104 receives and parses the above carrier object and extracts the signature information from the carrier object. The above second client terminal 104 sends the extracted signature information to the third client terminal 106. After receiving the above signature message, the third client terminal 106 may perform operations on the signature information to obtain feedback information. A feedback message is sent to the second client terminal 104. After receiving the feedback information from the above third client terminal, the second client terminal 104 may determine whether to perform subsequent operations according to the feedback information. The above feedback message may be, but is not limited to, “valid signature”, “invalid signature”, or other related feedback messages.

It should be noted that the above second client terminal 104 may not have the ability to verify the signature information, and the third client terminal 106 is required to assist in verifying the above signature information, for example, verifying the correctness, validity, etc., of the above signature information. Alternatively, the above second client terminal 104 has the ability to verify the signature information, but the above third client terminal 106 is required to assist in further confirming the validity of the above signature information.

In another example embodiment, for example, the above hidden information is the signature information. The first client terminal may process a document (a picture), for example, using a digest algorithm such as a hash function, to obtain first digest information of the document. the first client terminal may encrypt the first digest information to obtain a signature information. The above first client terminal may, but not limited to, encrypt the first digest information by means of a private key.

In the above example embodiment, the first client terminal may process the signature information by means of information hiding, for example, embedding a signature information into a carrier object to obtain a carrier object carrying the above signature message. The above signature message may be, but is not limited to, a signature on the carrier object. The signature information of the carrier object is embedded into the carrier object, so that the second client terminal (the receiver) and the third client terminal (the processor) verify the above signature information.

In an example embodiment, the first client terminal sends the carrier object carrying the above signature information to the second client terminal. After receiving the carrier object, the above second client terminal receives and parses the above carrier object and extracts the signature information from the carrier object. The above second client terminal deletes the signature information and obtains the above document. The above second client terminal uses the same digest algorithm to process the document to obtain second digest information of the document.

In another example embodiment, the second client terminal directly sends the extracted signature information to the third client terminal. Alternatively, the above second client terminal sends the carrier object to the third client terminal. After receiving the carrier object, the third client terminal parses the above carrier object and extracts the signature information from the carrier object. After receiving the above signature message, the third client terminal decrypts the signature information by using the public key corresponding to the above private key, so as to obtain the third digest information of the above document. The third client terminal feeds back the third digest information to the second client terminal.

In the above example embodiment, after the above second client terminal receives the third digest information fed back by the above third client terminal, the above second client terminal may compare the locally obtained second digest information with the third digest information fed back by the third client terminal to obtain a comparison result. The above second client terminal may determine whether the above document is damaged during communication transmission and whether to perform subsequent operations according to the above comparison result. If the comparison result is consistent, it is determined that the above document is not damaged during the communication transmission, and necessary subsequent operations may continue. If the comparison result is inconsistent, it is determined that the above document is damaged during the communication transmission, and the subsequent operation may stop.

Still, it should be noted that any of the exemplary communication methods of the present application may be performed or implemented in the communication system provided by this example embodiment.

### Embodiment 2

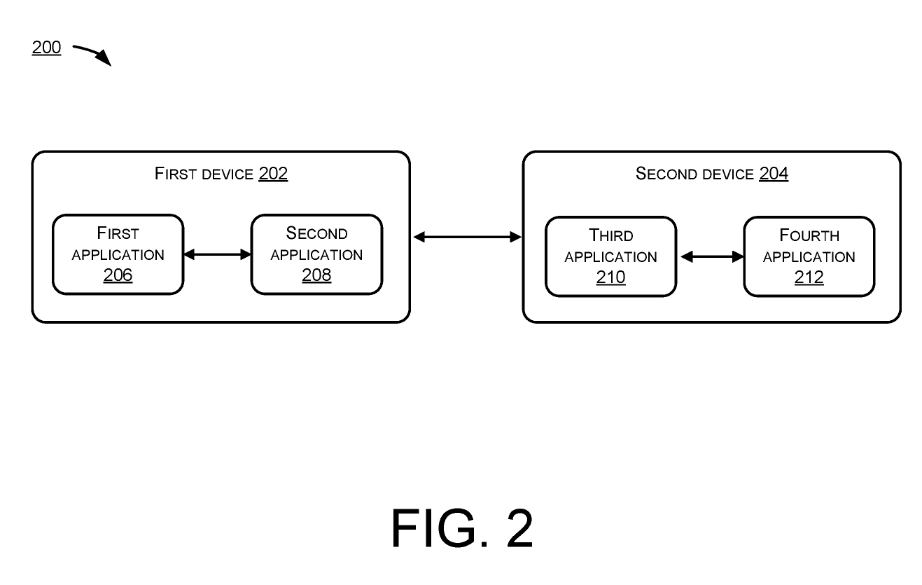

Prior to describing further details of various example embodiments of the present application, another suitable communication system example embodiment that may be used to implement the principles of the present application will be described with reference to FIG. 2.

FIG. 2 is a schematic structural diagram of another communication system 200 according to an example embodiment of the present application. For the purposes of the description, the depicted structure is only one example of a suitable environment and is not intended to limit the scope of the application, nor should the communication system 200 be interpreted as having any dependency or requirement on any of the components or combinations thereof shown in FIG. 2.

According to another example embodiment of the present application, another communication system 200 is also provided. As shown in FIG. 2, the above communication system 200 includes a first device 202 and a second device 204. The first device 202 runs the first application 206 and the second application 208. The above second device 204 runs a third application 210 and a fourth application 212.

In an example embodiment, the above first device 202 and second device 204 may be, but are not limited to, a mobile terminal device, a computer terminal device. The above first application 206, the above second application 208, the above third application 210 and the above fourth application 212 are applications running on different devices.

In another example embodiment, the above first application 206 and fourth application 212 are the same application that is logged in with different accounts and run on different devices. The above second application 208 and third application 210 are the same application that is logged in with different accounts and run on different devices.

In an example embodiment provided by the present application, the above first application 206 is configured to generate a carrier object carrying hidden information. The above second application 208 is configured to issue the above carrier object.

In an example embodiment, the above first application 206 may be any shopping type applications, for example, application software such as Suning, Jingdong, Vipshop, and the like. The above second application 208 may be a communication application, for example, any type of instant messaging software such as WeChat, QQ, and the like. The above carrier object may be an image, a text document, a web page, video, audio, and the like. The above hidden information may be presented in the form of a barcode, a two-dimensional code, or the like. The above hidden information may be, but is not limited to, a product promotion or discount information, for example, a scan code for receiving a red pocket, a scan code for an immediate discount, and the like.

In addition, the above hidden information may also be information associated with the carrier object. The meaning of the “associate” includes, but is not limited to, mapping relationship with the carrier object, sharing a designated resource such as preferential information and the like with the carrier object. In an alternative example embodiment, the information associated with the carrier object includes the signature information of the carrier object or description information of the carrier object. The information associated with the carrier object is generated by the first application 206. The above carrier object is issued by the above second application 208. For example, the above carrier object is distributed to the second device 204, such that the above second device 204 may use and manage the received carrier object.

In an example embodiment, the above first application 206 may, but is not limited to, generate a carrier object carrying hidden information by an information embedding algorithm in an information hiding manner.

It should be noted that the above hidden information may come from the above first application 206. For example, the above first application 206 generates the above hidden information according to the request data of the target object. In an example embodiment, the above first application 206 is further configured to obtain the above hidden information in the following manner. The above first application 206 receives the original information of the above hidden information from the above fourth application 212 and performs information hiding processing on the above original information to obtain the above hidden information.

For example, the above carrier object is an image. In the example embodiment of the present application, the above hidden information may be carried, but not limited to, in the following manners, i.e., embedding barcode information in any area in the image, embedding barcode information at the edge of the image; embedding two-dimensional code information in any area in the image, embedding the two-dimensional code information at the edge of the image.

In the example embodiment provided by the present application, the above third application 210 is configured to obtain the above carrier object issued by the second application and obtain valid identification information according to the feedback information fed back by the fourth application. The fourth application 212 is configured to obtain the above carrier object from the above third application when the preset trigger event is detected. The fourth application 212 is also configured to parse the above carrier object to obtain the above hidden information.

The fourth application 212 may run on a server, such as a cloud server, but is not limited thereto. The above fourth application 212 may, but not limited to, parse the above carrier object by an information extraction algorithm to obtain the above hidden information.

In an example embodiment, the above valid identification information includes at least one of the above hidden information and the signature information of the above carrier object.

In an example embodiment, the above preset trigger event includes at least one of the following, i.e., detecting that the third application receives the above carrier object, detecting an access operation of the above carrier object, and detecting that the above third application stores the above carrier object.

In an example embodiment, the above third application 210 may be a communication application, for example, any type of instant messaging software such as WeChat, QQ, and the like. The above third application may be the same type as the above second application. The above third application may also be a different type from the second application. In a case where the above third application is a different type from the second application, the above second application may send the above carrier object to the above third application in a sharing manner.

It should be noted that the above preset trigger event may be, but is not limited to, the third application 210 receiving the above carrier object, the third application 210 opening the above carrier object, and the like.

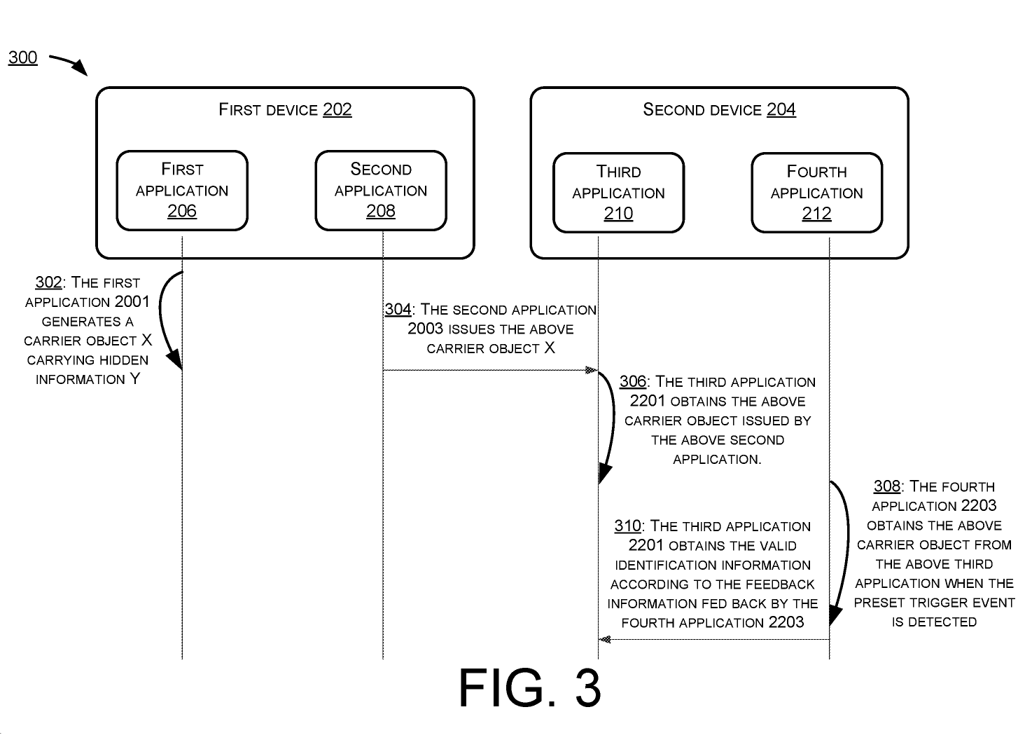

To understand the communication system provided by the present application, hereinafter, an example embodiment of the present application is described through an example communication solution. The first application and the fourth application may be, but are not limited to, two applications that do not support mutual communication. In order to implement information interaction between two applications that do not support communication, the example embodiment of the present application provides a corresponding solution, which is described in detail below with reference to FIG. 3.

FIG. 3 is a schematic diagram of an interaction process 300 in a communication system according to an example embodiment of the present application. The interaction process 300 of the first device 202 and the second device 204 may be, but is not limited to, as shown in FIG. 3.

Step 302: The first application 206 generates a carrier object X carrying hidden information Y.

In the above Step 302, the above first application 206 may embed the message Y to be sent or distributed in a carrier object in an information hiding manner, thereby generating a carrier object X carrying the hidden information Y.

In an example embodiment, the above first application 206 may, but not limited to, generate a carrier object carrying the hidden information by an information embedding algorithm in an information hiding manner.

Step 304: The second application 208 issues the above carrier object X.

In the above Step 304, the above second application 208 obtains the above carrier object X in the above first application 206 and distributes the carrier object X carrying the hidden information Y. The carrier object X carrying the hidden information Y may be sent separately or in groups. Also, the above carrier information may be posted to an address. For example, the above carrier object X may be sent in a WeChat group, or posted in WeChat Moments.

Step 306: The third application 210 obtains the above carrier object issued by the above second application.

In the above Step 306, the above third application 210 obtains the above carrier object issued by the above second application 208, for example, receiving the carrier object X from the second application 208 or storing the carrier object X from the second application 208.

Step 308: The fourth application 212 obtains the above carrier object from the above third application when the preset trigger event is detected. The fourth application 212 parses the above carrier object to obtain the above hidden information.

In the above Step 308, the above fourth application 212 obtains the above carrier object from the above third application when the preset trigger event is detected. The above fourth application 212 parses the above carrier object to obtain the above hidden information Y or the relevant information about above hidden information Y. The above fourth application 212 may, but not limited to, parse the above carrier object by an information extraction algorithm to obtain the above hidden information.

Step 310: The third application 210 obtains the valid identification information according to the feedback information fed back by the fourth application 212.

In an example embodiment, the above fourth application 212 is further configured to, after parting the above carrier information to obtain the hidden information, send the feedback information to the above third application based on the above carrier object. The above third application 210 is further configured to obtain the valid identification information based on the above feedback information.

In the above example embodiment, after parsing the above carrier object X to obtain the hidden information Y, the above fourth application 212 may process the above hidden information Y to obtain the feedback information, and then send the above feedback information to the third application 210. After receiving the feedback information, the third application 210 may obtain the valid identification information according to the feedback information, for example, the above hidden information, the signature information of the above carrier object.

It should be noted that during the entire communication process, the above second application 208 and the third application 210 may not have the ability to independently process the hidden information. Therefore, the third application 210 is required to complete the communication by means of assistance and feedback of the third application 210.

Still, it should be noted that any of the exemplary communication methods of the present application may be performed or implemented in the communication system provided by this example embodiment.

### Embodiment 3

According to an example embodiment of the present disclosure, an example embodiment of a communication method is also provided. It should be noted that the steps illustrated in the flowchart of the drawings may be performed in a computer system including a set of computer-executable instructions. Moreover, although logical sequences are shown in the flowcharts, in some cases the steps shown or described may be performed in a different order than the order described herein.

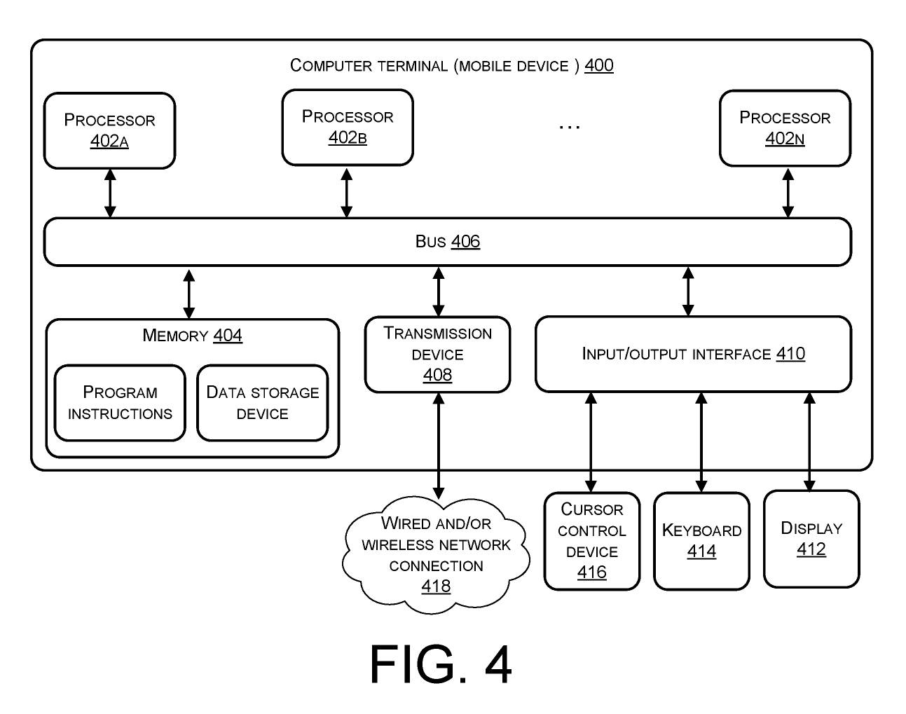

The example embodiments of method provided by the present application may be implemented in a mobile terminal, a computer terminal, or the like. FIG. 4 shows a structural block diagram of the hardware of a computer terminal 400 (or mobile device 400) for implementing a communication method. As shown in FIG. 4, the computer terminal 400 (or mobile device 10) may include one or more processor(s) 402a, 402b, . . . , 402n, a memory 404 for storing data, a bus 406, a transmission module 408 for performing communication functions, and an input/output interface 410. A respective one of the processor(s) 402a, 402b, . . . , 402n may include, but not limited to, a processing device such as a microprocessor MCU or a programmable logic device FPGA. In addition, the input/output interface 410 may communicate with a display 412, a keyboard 414, and a cursor control device 416. A universal serial bus (USB) port may be included as one of the ports that may serve as an I/O interface. The computer terminal 400 (or the mobile device 400) may further include a network interface, a power supply, and/or a camera (not shown). The transmission device 408 may be coupled to wired and/or wireless network connections 418. A person of ordinary skill in the art may understand that the structure shown in FIG. 4 is merely illustrative and does not limit the structure of the above electronic device. For example, computer terminal 400 may also include more or fewer components than the components shown in FIG. 4 or have a different configuration than the configuration shown in FIG. 4.

It should be noted that the above one or more processors 402a, 402b, . . . , 402n and/or other data processing circuits may be referred to herein as “data processing circuits.” The data processing circuit may be embodied in whole or in part as software, hardware, firmware or any other combination. Moreover, the data processing circuitry may be a single independent processing module, or incorporated in whole or in part into any of the other components in the computer terminal 400 (or mobile device 400). As referred to in the example embodiments of the present application, the data processing circuit as a processor controls, for example, selection of a variable resistance terminal path connected to the interface.

The memory 404 may be used to store software programs and modules of application software, such as program instructions/data storage devices corresponding to the communication methods in the example embodiments of the present disclosure. The processor(s) 402a, 402b, . . . , 402n execute various functional applications and data processing by running software programs and modules stored in the memory 404, that is, a communication method for implementing the above application. The memory 404 may include high-speed random access memory and may also include non-volatile memory such as one or more magnetic storage devices, flash memories, or other non-volatile solid-state memories. In some examples, the memory 404 may further include memory remotely located with respect to the processor(s) 402a, 402b, . . . , 402n, which may be coupled to the computer terminal 400 via a network. Examples of the above network include, but are not limited to, the Internet, an Intranet, a local area network, a mobile communication network, and combinations thereof.

The transmission device 408 is configured to receive or send data via a network. The example of the network may include a wireless network provided by a communication provider of the computer terminal 400. In an example, the transmission device 408 includes a Network Interface Controller (NIC) that can be connected to other network devices through a base station to communicate with the Internet. In an example, the transmission device 408 may be a Radio Frequency (RF) module which is configured to communicate with the Internet in a wireless manner.

The display 412 may be a touch screen liquid crystal display (LCD) that enables a user to interact with a user interface of the computer terminal 400 (or mobile device 400).

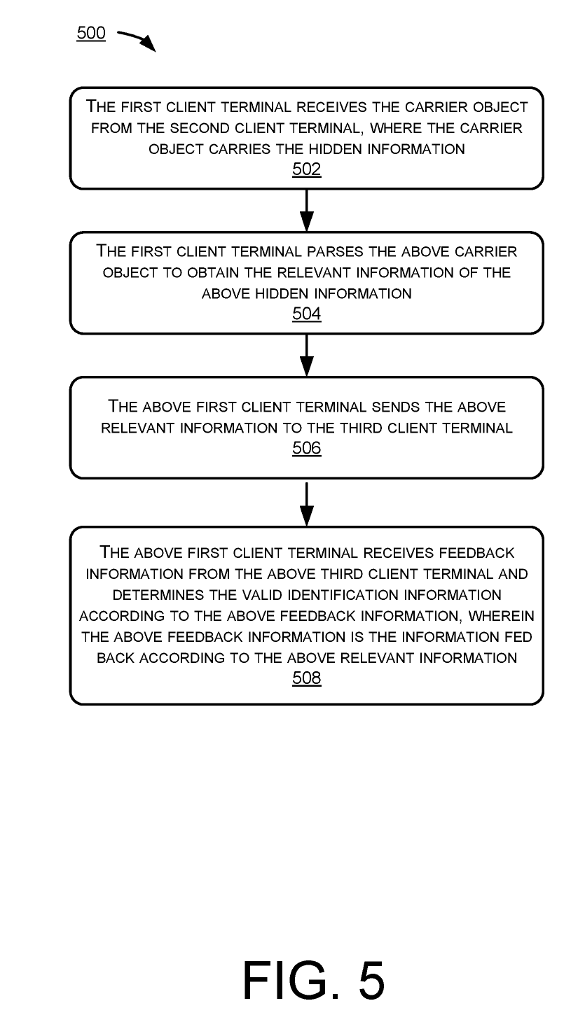

In the above operating environment, the present application provides a communication method 500 as shown in FIG. 5. It should be noted that the communication method 500 provided by the present application may be performed or operated in the communication systems provided in the above Embodiments 1 and 2. FIG. 5 is a flowchart of a communication method 500 according to an example embodiment of the present disclosure. As shown in FIG. 5, the communication method 500 provided by the example embodiment of the present application may be implemented by the following steps:

Step 502: The first client terminal receives the carrier object from the second client terminal, where the carrier object carries the hidden information.

It should be noted that the above second client terminal may be, but is not limited to, the first client terminal 102 in Embodiment 1. The above second client terminal may be any shopping type of client terminal, for example, Suning, Jingdong, Vipshop, and the like. In an example embodiment, the above first client terminal may be, but is not limited to, the third client terminal 106 in the above Embodiment 1. The first client terminal may be, but is not limited to, a server, such as a cloud server.

In an example embodiment, the above second client terminal may, but not limited to, generate the carrier object carrying the hidden information by an information embedding algorithm in the information hiding manner.

In an example embodiment, the above carrier object may be an image, a text document, a web page, video, audio, and the like. The above hidden information may be presented in the form of a barcode, a two-dimensional code, or the like. The above hidden information may be, but is not limited to, a product promotion or discount information, for example, a scan code for receiving a red pocket, a scan code for an immediate discount, and the like.

In an example embodiment, if the above carrier object is a product image, the above hidden information is promotion or price comparison-relevant information of the product (such as a URL link). In addition, the above hidden information may also be the information associated with the carrier object, such as the signature information of the carrier object or the description information of the carrier object. The second client terminal (the sender) generates the carrier object carrying the hidden information, such that the first client terminal (receiver) may use and manage the received carrier object.

For example, the above carrier object is an image. In the example embodiment of the present application, the above hidden information may be carried, but not limited to, in the following manners, i.e., embedding barcode information in any area in the image, embedding barcode information at the edge of the image; embedding two-dimensional code information in any area in the image, embedding the two-dimensional code information at the edge of the image.

Step 504: The above first client terminal parses the above carrier object to obtain the relevant information of the above hidden information.

In the above Step S504, the above first client terminal may send the above feedback information to the above third client terminal according to the above relevant information by an information extraction algorithm.

It should be noted that the above relevant information may or may not be consistent with the above hidden information. The above relevant information may include, but not limited to, one or more hidden messages.

Step 506: The above first client terminal sends the above relevant information to the third client terminal.

In the above Step 506, the third client terminal may be, but is not limited to, the second client terminal 104 in the above Embodiment 1. The third client terminal may be a communication application, for example, any type of instant messaging software such as WeChat or QQ.

It should be noted that during the entire communication process, the third client terminal may not have the ability to independently process the relevant information of the hidden information. Therefore, the above third client terminal requires the assistance and feedback of the first client terminal to complete the communication.

Step 508: The above first client terminal receives feedback information from the above third client terminal and determines the valid identification information according to the above feedback information, wherein the above feedback information is the information fed back according to the above relevant information.

It should be noted that the above first client terminal, second client terminal and third client terminal are applications running on the same device or different devices, wherein the device may be, but is not limited to, a mobile terminal device, a computer terminal device.

In an example embodiment, the present application is described with reference to an example communication solution. The above first client terminal receives and parses the above carrier object to obtain the relevant information of the hidden information. The above first client terminal transmits the relevant information of the hidden information to the first client terminal. After receiving the above relevant information of the hidden information, the third client terminal may process the above relevant information to obtain the feedback information, and then send the above feedback information to the above first client terminal according to the above relevant information. After receiving the feedback information from the above third client terminal, the first client terminal may determine whether to perform subsequent operations according to the feedback information, for example, to stop performing subsequent operations, or to perform necessary subsequent operations.

In the above example embodiment, if the above feedback information is a feedback message containing an error message, the first client terminal stops performing subsequent operations, and the entire communication process ends. If the feedback information is a valid feedback message, the first client terminal performs further operations based on the feedback message, and the above first client terminal may obtain the valid identification information according to the feedback information fed back by the third client terminal.

It should be noted that during the entire communication process, the first client terminal may not have the ability to independently process the relevant information of the hidden information. Therefore, the above first client terminal requires assistance and feedback from the third client terminal to complete the communication.

In an example embodiment, if the above relevant information includes the signature information, the above feedback information includes a verification result of the above signature information. Alternatively, if the above relevant information includes two-dimensional code information, the above feedback information includes a recognition result of the above two-dimensional code information.

In an example embodiment, for example, the above hidden information is the signature information. The second client terminal may embed the signature message into the carrier object to obtain the carrier object carrying the above signature message. The above signature message may be, but is not limited to, a signature on the carrier object. The signature information of the carrier object is embedded in the carrier object, so that the first client terminal (the receiver) may verify the signature information.

The second client terminal sends the carrier object information carrying the above signature information to the first client terminal. The above first client terminal receives and parses the above carrier object after receiving the carrier object and extracts the signature information from the carrier object. The above first client terminal sends the extracted signature information to the third client terminal. After receiving the above signature message, the above third client terminal may operate the signature information to obtain the feedback information. The above third client terminal sends the feedback message to the first client terminal. After receiving the feedback information of the above third client terminal, the first client terminal may determine whether to perform a subsequent operation according to the feedback information. The above feedback message may be, but is not limited to, “valid signature”, “invalid signature” or other related feedback message.

It should be noted that the above first client terminal may not have the ability to verify the signature information, and the third client terminal is required to assist in verifying the above signature information, for example, verifying the correctness, validity, etc., of the above signature information. Alternatively, the above first client terminal has the ability to verify the signature information, but the above third client terminal is required to assist in further confirming the validity of the above signature information.

Based on the solution defined by the above example embodiment, it can be known that the carrier object from the second client terminal is received by the first client terminal, where the carrier object carries hidden information. The above first client terminal parses the above carrier object to obtain the relevant information of the above hidden information. The above first client terminal sends the above relevant information to the third client terminal. The above first client terminal receives the feedback information from the above third client terminal and determines the valid identification information based on the above feedback information, where the above feedback information is the information fed back based on the above relevant information.

With the solution provided by the above example embodiment of the present application, the transmission of the hidden information does not attract the attention and concern of the third party. The purpose of ensuring the secure and reliable transmission of the hidden information is guaranteed, thereby achieving the technical effect that the possibility of the transmitted hidden information being attacked by the third party is reduced. As such, the technical problem that it is still difficult for the existing communication solution to guarantee the security and reliability of the transmission of the hidden information is solved.

In addition, it should be noted that the exemplary implementations of this example embodiment may be referred to related descriptions in Embodiments 1 and 2, and details may not be described herein again.

### Embodiment 4

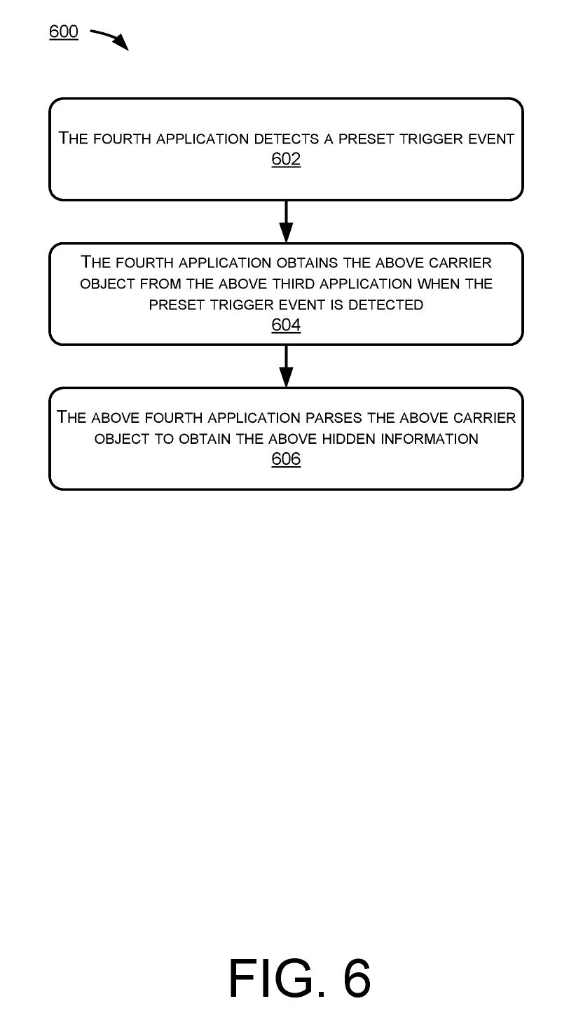

The present application also provides a communication method 600 as shown in FIG. 6. It should be noted that the communication method 600 provided by the present application may be performed or operated in the communication system provided in the above Embodiments 1 and 2. FIG. 6 is a flowchart of another communication method 600 according to an example embodiment of the present disclosure. As shown in FIG. 6, the communication method 600 provided by the example embodiment of the present application may be implemented by the following steps:

Step 602: The fourth application detects a preset trigger event.

In an example embodiment, the above preset trigger event includes at least one of the following, i.e., detecting that the third application receives the above carrier object, detecting an access operation of the above carrier object, and detecting that the third application stores the above carrier object.

Step 604: The fourth application obtains the above carrier object from the above third application when the preset trigger event is detected, where the carrier object carries the hidden information. The above third application obtains the above carrier object from the content issued by the second application. The above carrier object is a carrier object generated by the first application.

In the above Step 604, the above first application may, but not limited to, generate the carrier object carrying the hidden information by an information embedding algorithm in the information hiding manner. The above second application obtains the above first application and distributes the carrier object containing the hidden information. The above carrier object containing the hidden information may be sent separately or in groups. Also, the above carrier object containing the hidden information may be posted to an address. For example, the above carrier object may be sent in a WeChat group or posted in WeChat Moments. The above third application may, but not limited to, obtain the above carrier object issued by the above second application in the following manners, i.e., receiving the carrier object from the second application or storing the carrier object from the second application.

Step 606: The above fourth application parses the above carrier object to obtain the above hidden information.

In Step 606, the above fourth application 212 obtains the above carrier object from the above third application when the preset trigger event is detected and parses the above carrier object to obtain the above hidden information or the relevant information of the above hidden Information. In an example embodiment, the above fourth application may, but not limited to, parse the above carrier object by an information extraction algorithm to obtain the above hidden information.

Through the solution provided by the above example embodiment of the present application, the transmission of the hidden information does not attract the attention and concern of the third party. The purpose of ensuring the secure and reliable transmission of the hidden information is guaranteed, thereby achieving the technical effect that the possibility of the transmitted hidden information being attacked by the third party is reduced. As such, the technical problem that it is still difficult for the existing communication solution to guarantee the security and reliability of the transmission of the hidden information is solved.

In an example embodiment, the above first application and the fourth application are the same applications that are logged in with different accounts and run on different devices. The above second application and the third application are the same application that is logged in with different accounts and runs on different devices.

In an example embodiment, the above method 600 further includes the following steps:

The fourth application sends the above hidden information to the above third application. The above third application determines the valid identification information of the above carrier object based on the above hidden information.

In the above example embodiment, after parsing the above carrier object to obtain the hidden information, the above fourth application may process the above hidden information to obtain the feedback information, and then send the above feedback information to the third application. After receiving the feedback information, the third application may obtain the valid identification information according to the feedback information, for example, the above hidden information, the signature information of the above carrier object.

In an example embodiment, the above valid identification information includes at least one of the above hidden information and the signature information of the above carrier object.

In an example embodiment, the above valid identification information may be undecrypted hidden information itself, the decrypted hidden information, or an auxiliary information when the third application performs an operation. For example, when the third application performs an operation, it is necessary to determine whether the carrier object is legal, and the auxiliary information may be the determination result of the above determining process.

In addition, it should also be noted that the exemplary implementations of this example embodiment may be referred to the related descriptions in Embodiments 1 and 2, and details may not be described herein again.

It should be noted that, for the sake of simplicity, the above various example embodiments of method are described as a series of combinations of acts. However, a person of ordinary skill in the art should understand that the present disclosure is not limited by the described order of the acts. Because some steps may be performed in other sequences or concurrently according to the present disclosure. Secondly, a person of ordinary skill in the art should also understand that the example embodiments described in the specification only represent some example embodiments, and the acts and modules involved are exemplary for the present disclosure.

Through the description of the above example embodiments, a person of ordinary skill in the art may understand that the method according to the above example embodiments may be implemented by means of software plus a necessary general hardware platform. Of course, the method according to the above example embodiments may be implemented by means of hardware. However, in many cases, the former is a better implementation. Based on such understanding, the technical solution of the present disclosure, which is essential or contributes to the conventional techniques, may be embodied in the form of a software product. The computer software product is stored in a storage medium (such as ROM/RAM, disk, optical disc), which includes a plurality of instructions that causes a terminal device (which may be a cell phone, a computer, a server, a network device, etc.) to perform the above methods of various example embodiments of the present disclosure.

### Embodiment 5

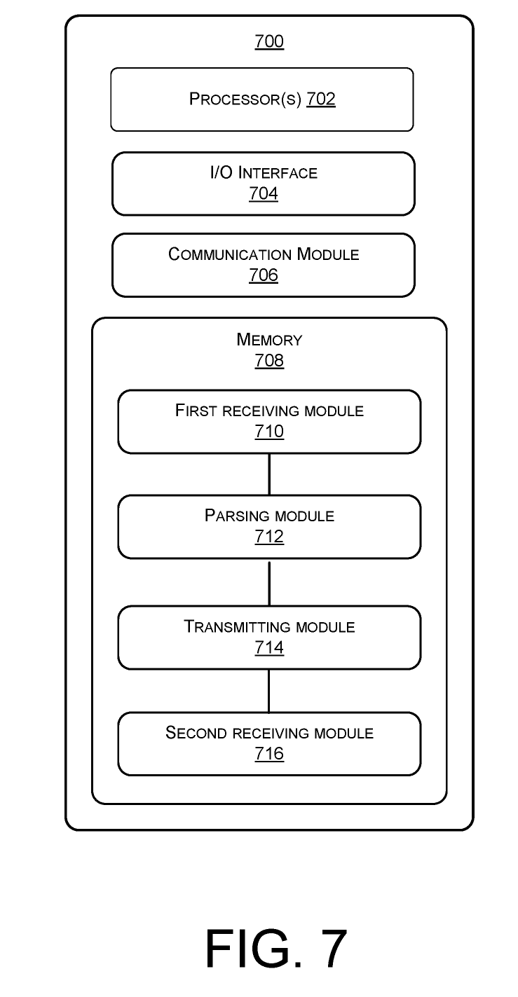

According to an example embodiment of the present disclosure, a communication apparatus 700 for implementing the above communication method is also provided. FIG. 7 is a schematic structural diagram of a communication apparatus 700 according to an example embodiment of the present disclosure. As shown in FIG. 7, the apparatus 700 includes one or more processors 702, an input/output (I/O) module 704, a communication module 706, and a memory 708. The input/output module 704 is configured to receive data/signal to be processed and to output the processed data/signal. The communication module 706 is configured to allow the apparatus 700 to communicate with other devices (not shown) over a network (not shown). The memory 708 stores thereon computer-executable modules executable by the one or more processors 702, the computer-executable modules may include a first receiving module 710, a parsing module 712, a sending module 714, and a second receiving module 716.

The first receiving module 710 is configured to receive a carrier object from the second client terminal, where the carrier object carries the hidden information. The parsing module 712 is configured to parse the above carrier object to obtain the relevant information of the above hidden information. The sending module 714 is configured to send the above relevant information to the third client terminal. The second receiving module 716 is configured to receive the feedback information from the third client terminal and determine the valid identification information according to the above feedback information, where the above feedback information is the information fed back according to the above relevant information.

Here, the first receiving module 710, the parsing module 712, the sending module 714, and the second receiving module 716 correspond to Step 502 to Step 508 in Embodiment 3. These four modules are identical to examples and application scenarios implemented by corresponding steps but are not limited to the contents disclosed in the above Embodiment 3. It should be noted that the above modules may run as part of the device in the computer terminal 400 provided in Embodiment 3.

Still, it should be noted that the exemplary implementations of this example embodiment may be referred to related descriptions in Embodiments 1, 2, 3, and 4, which may not be described herein again.

### Embodiment 6

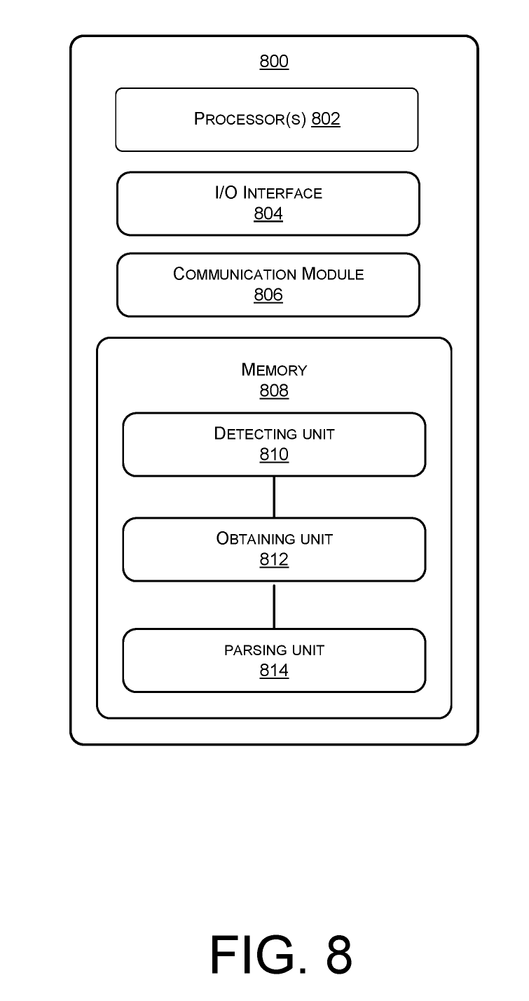

According to an example embodiment of the present disclosure, a communication apparatus 800 for implementing the above communication method is also provided. FIG. 8 is a schematic structural diagram of another communication apparatus 800 according to an example embodiment of the present disclosure. As shown in FIG. 8, the apparatus 800 includes one or more processors 802, an input/output module 804, a communication module 806, and a memory 808. The input/output module 804 is configured to receive data/signal to be processed and to output the processed data/signal. The communication module 806 is configured to allow the apparatus 800 to communicate with other devices (not shown) over a network (not shown). The memory 808 stores thereon computer-executable modules executable by the one or more processors 802, the computer-executable modules may include a detecting unit 810, an obtaining unit 812, and a parsing unit 814.

The detecting unit 810 is configured to detect the preset trigger event. The obtaining unit 812 is configured to obtain the carrier object from the third application when the fourth application detects the above preset trigger event, where the carrier object carries the hidden information. The above third application obtains the above carrier object from the content issued by the second application. The above carrier object is the carrier object generated by the first application. The parsing unit 814 is configured to parse the above carrier object to obtain the above hidden information.

Here, it should be noted that the above detecting unit 810, the obtaining unit 812, and the parsing unit 814 correspond to Step 602 to Step 606 in Embodiment 4. These three units are identical to examples and application scenarios implemented by corresponding steps but are not limited to the contents described in the above Embodiment 4. It should be noted that the above units may run as part of the device in the computer terminal 400 provided in Embodiment 3.

Still, it should be noted that the exemplary implementations of this example embodiment may be referred to related descriptions in Embodiments 1, 2, 3, 4, and 5, which may not be described herein again.

### Embodiment 7

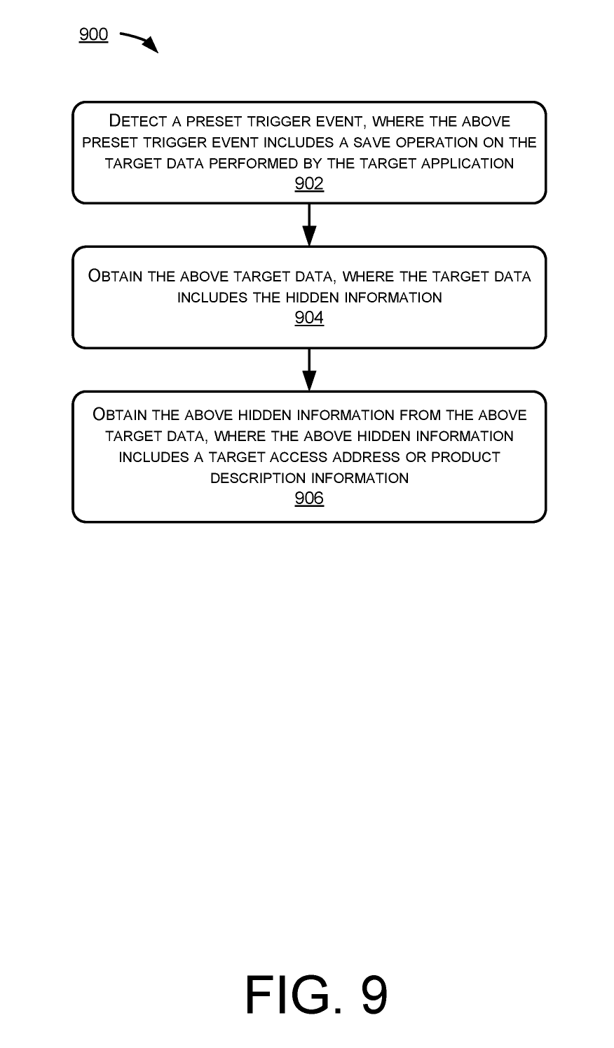

The present application also provides a data processing method 900 as shown in FIG. 9. It should be noted that the data processing method 900 provided by the present application may be performed or operated in the communication system provided in the above Embodiments 1 and 2. FIG. 9 is a flowchart of a data processing method 900 accordingly an example embodiment of the present disclosure. As shown in FIG. 9, the data processing method 900 provided by the example embodiment of the present application may be implemented by the following steps:

Step 902: A preset trigger event is detected, where the above preset trigger event includes a save operation on the target data performed by the target application.

In an example embodiment, the execution subject of the above Step 902 may be, but is not limited to, an application. The application may be the fourth application 212 of the above in Embodiment 2. The fourth application may run on a server, such as a cloud server, but is not limited thereto.

In an example embodiment, the above target data may include, but not limited to, image data, video data, or audio data.

In the above Step 902, the above preset trigger event may also be any one of the following events, i.e., detecting that the target application receives the above target data, detecting the access operation of the above target data, and opening operation on the target data performed by the target application.

Step 904: The above target data is obtained, where the target data includes the hidden information.

In the above Step 904, when the above fourth application detects the above preset trigger event, the above fourth application may, but not limited to, obtain the target data from the third application (for example, the third application 210 in Embodiment 2 of the present application), where the target data carries the above hidden information. The above third application obtains the above target data from content issued by the second application (for example, the second application 208 in Embodiment 2 of the present application). The above target data is the carrier object generated by the first application (for example, the first application 206 in Embodiment 2 of the present application).

In an example embodiment, the above first application may, but not limited to, generate the target data carrying the hidden information by an information embedding algorithm in an information hiding manner. The above second application obtains the above target data in the above first application and distributes the target data containing the hidden information. The target data containing the hidden information may be sent separately or in groups. Also, the above carrier information may be posted to an address. For example, the above target data may be sent in a WeChat group, or post in WeChat Moments. The above third application may, but not limited to, obtain the above target data issued by the above second application in the following manners, i.e., receiving the target data from the second application or storing the target data from the second application.

In the example embodiment of the present application, for example, the above target data is image data. The target data may contain the hidden information, but not limited to, in the following manners, i.e., embedding barcode information in any area in the image data, embedding barcode information at the edge of the image data, embedding two-dimensional code information in any area in the image data, embedding the two-dimensional code information at the edge of the image.

Step 906: The above hidden information is obtained from the above target data, where the above hidden information includes a target access address or product description information.

In an example embodiment, the above fourth application may, but not limited to, parse the above carrier object by an information extraction algorithm to obtain the above hidden information. In an example embodiment, the above product description information may include, but not limited to, a product ID, a product discount information, a target access address of the target data (a URL link), and may also include the signature information of the above target data or the description information of the target data.

Based on the solution defined by the above example embodiment, it may be known that the above target data is obtained by detecting the preset trigger event, where the above preset trigger event includes the save operation on the target data performed by the target application. The target data includes the hidden information. The above hidden information is obtained from the above target data, where the above hidden information includes the target access address or the product description information.

Through the solution provided by the above example embodiment of the present application, the transmission of the hidden information does not attract the attention and concern of the third party. The purpose of ensuring the secure and reliable transmission of the hidden information is guaranteed, thereby achieving the technical effect that the possibility of the transmitted hidden information being attacked by the third party is reduced. As such, the technical problem that it is still difficult for the existing communication solution to guarantee the security and reliability of the transmission of the hidden information is solved.

### Embodiment 8

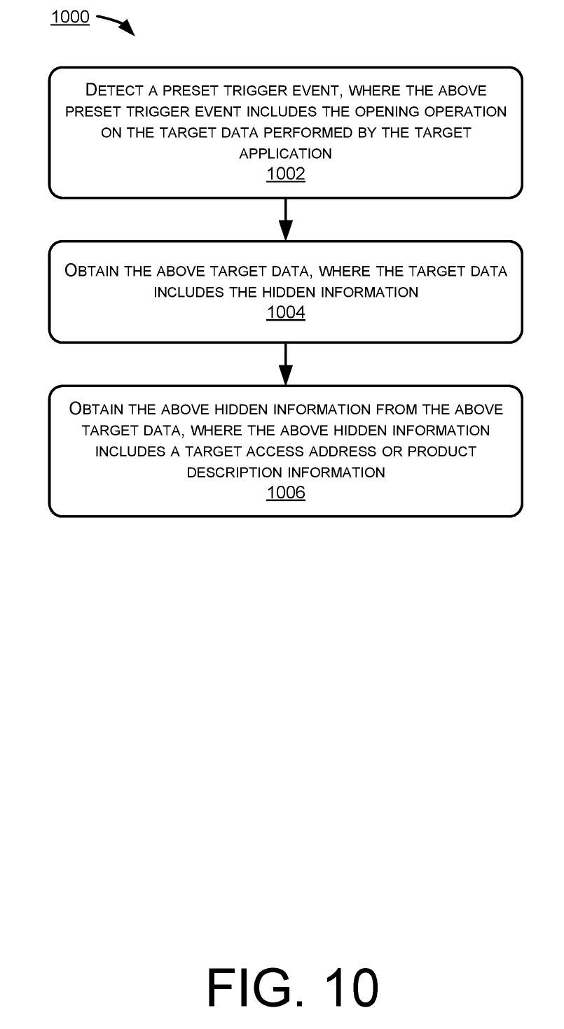

The present application also provides a data processing method 1000 as shown in FIG. 10. It should be noted that the data processing method 1000 provided by the present application may be, but is not limited to, performed or operated in the communication system provided in the above Embodiments 1 and 2. FIG. 10 is a flowchart of another data processing method 1000 according to an example embodiment of the present disclosure. As shown in FIG. 10, the data processing method 1000 provided by the example embodiment of the present application may be implemented by the following steps:

Step 1002: A preset trigger event is detected, where the above preset trigger event includes the opening operation on the target data performed by the target application.

In an example embodiment, the above target data may include, but not limited to, image data, video data, or audio data.

In an example embodiment, the execution subject of the above Step 1002 may be, but is not limited to, the fourth application, which may use the fourth application 212 in the above in Embodiment 2. The fourth application may run on a server, such as a cloud server, but is not limited thereto.

In an example embodiment, the above target data may include, but not limited to, image data, video data, or audio data.

In the above Step 1002, the above preset trigger event may also be any one of the following events, i.e., detecting that the target application receives the above target data, the save operation on the target data performed by the target application.

Step 1004, the above target data is obtained, where the target data includes the hidden information.

In the above Step 1004, when the above fourth application detects the above preset trigger event, the above fourth application may, but not limited to, obtain the target data from the third application (for example, the third application 210 in Embodiment 4 of the present application), where the target data carries the above hidden information. The above third application obtains the above target data from the content issued by the second application (for example, the second application 208 in Embodiment 4 of the present application). The above target data is the carrier object generated by the first application (for example, the first application 206 in Embodiment 4 of the present application).

In the example embodiment of the present application, for example, the above target data is image data. The target data may contain the hidden information, but not limited to, in the following manners, i.e., embedding barcode information in any area in the image data, embedding barcode information at the edge of the image data, embedding two-dimensional code information in any area in the image data, embedding the two-dimensional code information at the edge of the image.

Step 1006, the above hidden information is obtained from the above target data, where the above hidden information includes a target access address or product description information.

In an example embodiment, the above fourth application may, but not limited to, parse the above carrier object by an information extraction algorithm to obtain the above hidden information.

In an example embodiment, the above product description information may include, but not limited to, a product ID, a product discount information, a target access address, and may also include the signature information of the above target data or the description information of the target data, where the above target access address may be a target access address of the target data (a URL link).

Based on the solution defined by the above example embodiment, it may be known that the above target data is obtained by detecting the preset trigger event, where the above preset trigger event includes the opening operation on the target data performed by the target application. The target data includes the hidden information. The above hidden information is obtained from the above target data, where the above hidden information includes the target access address or the product description information.

Through the solution provided by the above example embodiment of the present application, the transmission of the hidden information does not attract the attention and concern of the third party. The purpose of ensuring the secure and reliable transmission of the hidden information is guaranteed, thereby achieving the technical effect that the possibility of the transmitted hidden information being attacked by the third party is reduced. As such, the technical problem that it is still difficult for the existing communication solution to guarantee the security and reliability of the transmission of the hidden information is solved.

### Embodiment 9

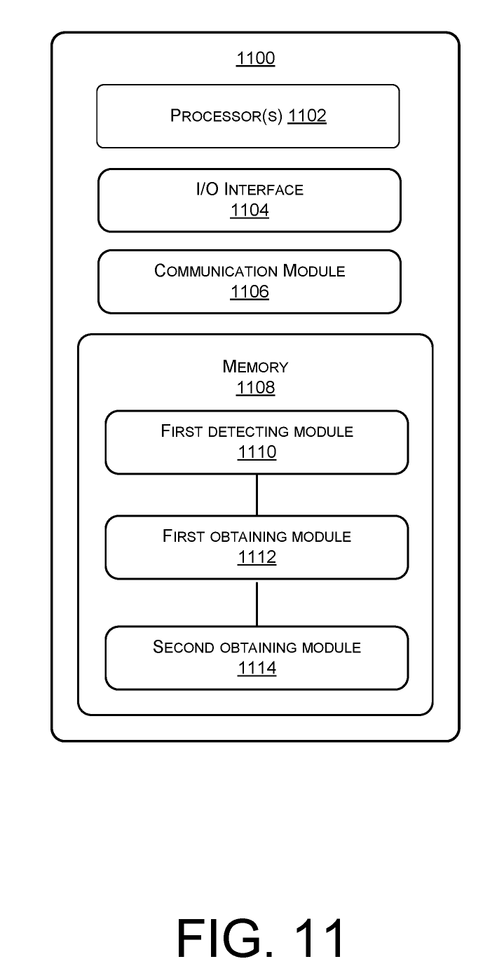

According to an example embodiment of the present disclosure, a data processing apparatus 1100 for implementing the above data processing method is also provided. FIG. 11 is a schematic structural diagram of a data processing apparatus 1100 according to an example embodiment of the present disclosure. As shown in FIG. 11, the device 1100 includes one or more processors 1102, an input/output module 1104, a communication module 1106, and a memory 1108. The input/output module 1104 is configured to receive data/signal to be processed and to output the processed data/signal. The communication module 1106 is configured to allow the apparatus 1100 to communicate with other devices (not shown) over a network (not shown). The memory 1108 stores thereon computer-executable modules executable by the one or more processors 1102, the computer-executable modules may include a first detecting module 1110, a first obtaining module 1112, and a second obtaining module 1114.

The first detecting module 1110 detects a preset trigger event, where the upper preset trigger event includes a save operation on the target data performed by the target application. The first obtaining module 1112 is configured to obtain the above target data, where the target data includes the hidden information. The second obtaining module 1114 is configured to obtain the above hidden information from the above target data, where the above hidden information includes the target access address or the product description information.

Here, it should be noted that the above first detecting module 1110, the first obtaining module 1112, and the second obtaining module 1114 correspond to Step 902 to Step 906 in Embodiment 7. These three modules are identical to examples and application scenarios implemented by corresponding steps, but are not limited to the contents disclosed in the above Embodiment 7. It should be noted that the above modules may run as part of the device in the computer terminal 400 provided in Embodiment 3.

Still, it should be noted that the exemplary implementations of this example embodiment can be referred to the related descriptions in Embodiments 1, 2, 3, 4, 7, and 8, and are not described herein again.

### Embodiment 10

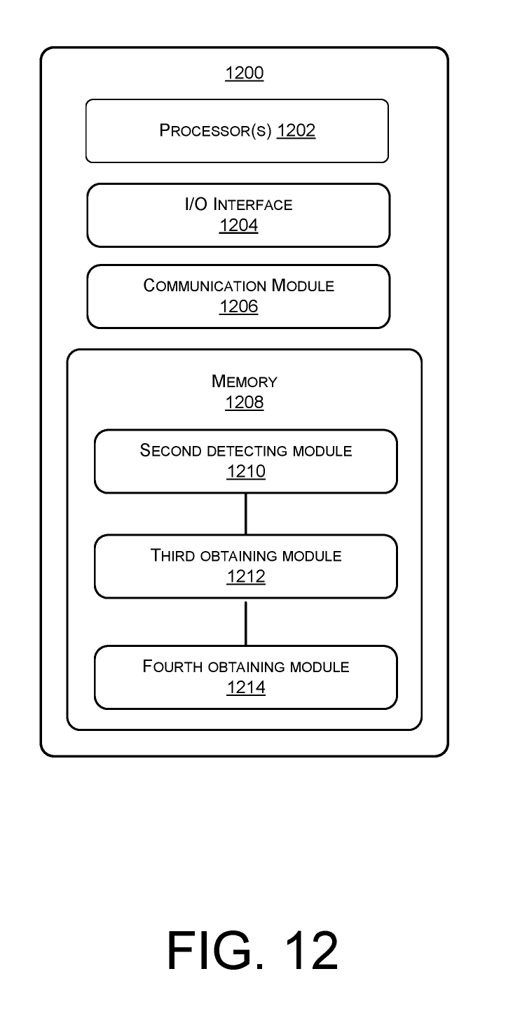

According to an example embodiment of the present disclosure, a data processing apparatus 1200 for implementing the above data processing method is also provided. FIG. 12 is a schematic structural diagram of another data processing apparatus 1200 according to an example embodiment of the present disclosure. As shown in FIG. 12, the device 1200 includes one or more processors 1202, an input/output module 1204, a communication module 1206, and a memory 1208. The input/output module 1204 is configured to receive data/signal to be processed and to output the processed data/signal. The communication module 1206 is configured to allow the apparatus 1200 to communicate with other devices (not shown) over a network (not shown). The memory 1208 stores thereon computer-executable modules executable by the one or more processors 1202, the computer-executable modules may include a second detecting module 1210, a third obtaining module 1212, and a fourth obtaining module 1214.

The second detecting module 1210 is configured to detect a preset trigger event, where the above preset trigger event includes an opening operation on the target data performed by the target application. The third obtaining module 1212 is configured to obtain the above target data, where the target data includes hidden information. The fourth obtaining module 1214 is configured to obtain the above hidden information from the above target data, where the above hidden information includes the target access address or the product description information.

Here, it should be noted that the above second detecting module 1210, the third obtaining module 1212, and the fourth obtaining module 1214 correspond to Step 1002 to Step 1006 in Embodiment 8. These three modules are identical to examples and application scenarios implemented by corresponding steps, but are not limited to the contents disclosed in the above Embodiment 8. It should be noted that the above units may run as part of the device in the computer terminal 400 provided in Embodiment 3.

Still, it should be noted that the exemplary implementations of this example embodiment may be referred to related descriptions in Embodiments 1, 2, 3, 4, 5, 6, 7, and 8, which may not be described herein again.

### Embodiment 11

The example embodiment of the present disclosure may further provide a computer terminal, which may be any computer terminal device in a computer terminal group. In an example embodiment, the above computer terminal may also be replaced with a terminal device such as a mobile terminal.

In an example embodiment, the above computer terminal may be located in at least one of a plurality of network devices of the computer network.

In this example embodiment, the above computer terminal can execute the program code of the following steps in the communication method. The first client terminal receives the carrier object from the second client terminal, where the carrier object carries the hidden information. The above first client terminal parses the above carrier object to obtain the relevant information of the above hidden information. The above first client terminal sends the above relevant information to the third client terminal. The above first client terminal receives feedback information from the above third client terminal and determines the valid identification information according to the above feedback information, wherein the above feedback information is the information fed back according to the above relevant information.

In an example embodiment, still as shown in FIG. 4, the computer terminal 400 may include one or more processor(s) 402a, 402b, . . . , 402n, a memory 404, a display device 412, and the like.

The memory 412 may be used to store software programs and modules, such as program instructions/modules corresponding to the communication methods and devices in the example embodiments of the present disclosure. The processor(s) 402a, 402b, . . . , 402n execute various functional applications and data processing by running software programs and modules stored in the memory, that is, implementing the above communication method. The memory 404 may include high-speed random access memory and may also include non-volatile memory such as one or more magnetic storage devices, flash memories, or other non-volatile solid-state memories. In some examples, the memory 404 may further include memory remotely located with respect to the processor(s), which may be coupled to the computer terminal 400 via a network. Examples of the above network include, but are not limited to, the Internet, an Intranet, a local area network, a mobile communication network, and combinations thereof.

The processor(s) 402a, 402b, . . . , 402n may invoke the information and the application stored in the memory 404 through the transmission device 408 to perform the following steps. The first client terminal receives the carrier object from the second client terminal, where the carrier object carries the hidden information. The above first client terminal parses the above carrier object to obtain the relevant information of the above hidden information. The above first client terminal sends the above relevant information to the third client terminal. The above first client terminal receives the feedback information from the above third client terminal and determines the valid identification information according to the above feedback information, where the above feedback information is the information fed back according to the above relevant information.

With the example embodiment of the present disclosure, a solution of a communication method is provided. The carrier object from the second client terminal is received by the first client terminal, where the carrier object carries the hidden information. The above first client terminal parses the above carrier object to obtain the relevant information of the above hidden information. The above first client terminal sends the above relevant information to the third client terminal. The above first client terminal receives the feedback information from the above third client terminal and determines the valid identification information according to the above feedback information, where the above feedback information is the information fed back according to the above relevant information. The transmission of the hidden information does not attract the attention and concern of the third party. The purpose of ensuring the secure and reliable transmission of the hidden information is guaranteed, thereby achieving the technical effect that the possibility of the transmitted hidden information being attacked by the third party is reduced. As such, the technical problem that it is still difficult for the existing communication solution to guarantee the security and reliability of the transmission of the hidden information is solved.

The processor(s) 402a, 402b, . . . , 402n may invoke the information and the application stored in the memory through the transmission device to perform the following steps. The fourth application detects the preset trigger event. The fourth application obtains the above carrier object from the above third application when the preset trigger event is detected, where the carrier object carries the hidden information. The above third application obtains the above carrier object from the content issued by the second application, where the above carrier object is the carrier object generated by the first application. The above fourth application parses the above carrier object to obtain the above hidden information.

In an example embodiment, the above the processor(s) 402a, 402b, . . . , 402n may further execute the program code of the following steps. The above fourth application sends the above hidden information to the above third application, where the above third application determines the valid identification information of the above carrier object based on the above hidden information.

The processor(s) 402a, 402b, . . . , 402n may invoke the information and the application stored in the memory 404 through the transmission device 408 to perform the following steps. The preset trigger event is detected, where the above preset trigger event includes the save operation on the target data performed by the target application. The above target data is obtained, where the target data includes the hidden information. The above hidden information is obtained from the above target data, where the above hidden information includes the target access address or the product description information.

The processor(s) 402a, 402b, . . . , 402n may invoke the information and the application stored in the memory 404 through the transmission device 408 to perform the following steps. The preset trigger event is detected, where the above preset trigger event includes the opening operation on the target data performed by the target application. The above target data is obtained, where the target data includes the hidden information. The above hidden information is obtained from the above target data, where the above hidden information includes the target access address or the product description information.

A person of ordinary skill in the art may understand that the structure shown in FIG. 4 is illustrative. The computer terminal 400 may also be a smart phone (such as an Android phone, an iOS phone, and the like), a tablet computer, a palm computer, and a Mobile Internet Device (MID), a PAD, and the like. FIG. 4 does not limit the structure of the above electronic device. For example, computer terminal 400 may also include more or fewer components (such as network interfaces, display devices, and the like) than the components shown in FIG. 4, or have a different configuration than the configuration shown in FIG. 4.

A person of ordinary skill in the art may understand that all or some of the steps of the above example embodiments may be completed by a program which instructs the hardware related to the terminal device. The program may be stored in a computer-readable storage medium. The storage medium may include a flash disk, a read-only memory (ROM), a random access memory (RAM), a magnetic disk, an optical disk, and the like.

### Embodiment 12

Example embodiments of the present disclosure also provide a storage medium. In an example embodiment, in the example embodiment, the above storage medium may be used to save the program code executed by the communication method provided by the above Embodiment 3.

In an example embodiment, the above storage medium may be located in any one of a computer terminal group in a computer network, or in any one of a mobile terminal group.

In an example embodiment, the storage medium is configured to store program code for performing the following steps. The first client terminal receives the carrier object from the second client terminal, where the carrier object carries the hidden information. The above first client terminal parses the above carrier object to obtain the relevant information of the above hidden information. The above first client terminal sends the above relevant information to the third client terminal. The above first client terminal receives the feedback information from the above third client terminal and determines the valid identification information according to the above feedback information, where the above feedback information is the information fed back according to the above relevant information.

In an example embodiment, the above storage medium may also be configured to store the program code executed by the location communication method of the target object provided by the above Embodiment 4. The fourth application detects the preset trigger event. The fourth application obtains the above carrier object from the above third application when the preset trigger event is detected, where the carrier object carries the hidden information. The above third application obtains the above carrier object from the content issued by the second application, where the above carrier object is the carrier object generated by the first application. The above fourth application parses the above carrier object to obtain the above hidden information.

In an example embodiment, the storage medium is configured to store program code for performing the following steps. The above fourth application sends the above hidden information to the above third application, where the above third application determines the valid identification information of the above carrier object based on the above hidden information.

In an example embodiment, the above storage medium may also be configured to store the program code executed by the location communication method of the target object provided by the above Embodiment 7. The preset trigger event is detected, where the above preset trigger event includes the save operation on the target data performed by the target application. The above target data is obtained, where the target data includes hidden information. The above hidden information is obtained from the above target data, where the above hidden information includes the target access address or the product description information.

In an example embodiment, the above the above storage medium may also be configured to store the program code executed by the location communication method of the target object provided by the above Embodiment 8. The preset trigger event is detected, where the above preset trigger event includes the opening operation on the target data performed by the target application. The above target data is obtained, where the target data includes hidden information. The above hidden information is obtained from the above target data, where the above hidden information includes the target access address or the product description information.

The serial numbers of the above example embodiments of the present disclosure are merely for the purpose of description, and do not represent the advantages and disadvantages of the example embodiments.

In the above example embodiments of the disclosure, the description of respective example embodiment has its own emphasis. For a part that is not detailed in an example embodiment, reference may be made to related descriptions of other example embodiments.

In the several example embodiments provided by the present application, it should be understood that the disclosed technical contents may be implemented in other manners. The example embodiments of device described above are merely illustrative. For example, the division of units is only a logical function division. In practice, the actual implementation may have other division manners. For example, multiple units or components may be combined or integrated into another system. Also, some features may be omitted or not implemented. Alternatively, mutual coupling, direct coupling, or communication connection shown or discussed may be through some interfaces. The indirect coupling or communication connection between units or modules may be in electrical or other forms.

The units described as separate components may or may not be physically separate. The components displayed as units may or may not be physical units, that is, may be located in one place, or may be distributed amount multiple network units. One or more the units may be selected according to actual needs to achieve the purpose of the solution of the example embodiments.

In addition, in the present disclosure, each functional unit in each example embodiment may be integrated into one processing unit. Alternatively, each unit may exist physically separately. Alternatively, two or more units may be integrated into one unit. The above integrated units may be implemented either in hardware or in the form of software functional units.

If the integrated unit is implemented in the form of a software functional unit and sold or used as a standalone product, it can be stored in a computer-readable storage medium. Based on such understanding, the technical solution of the present disclosure which is essential or contributes to the conventional techniques, or entire or part of the technical solution may be embodied in the form of a software product. The computer software product is stored in a storage medium, which includes a plurality of instructions that cause a computer device (which may be a personal computer, a server, a network device, etc.) to perform all or some of the steps of methods of various example embodiments of the present disclosure. The above storage medium includes various media that may store program codes such as a U disk, a Read-Only Memory (ROM), a Random Access Memory (RAM), a mobile hard drive, a magnetic disk, an optical disk, and the like.

The computer-readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

The above descriptions are only preferred example embodiments of the disclosure. It should be noted that several modifications and refinements may be made by a person of ordinary skill in the art without departing from the principles of the disclosure. Such modifications and refinements are also considered as falling within the scope of the disclosure.

### EXAMPLE CLAUSES

### Clause 1

A communication system, comprising: a first client terminal, configured to generate a carrier object carrying hidden information; a second client terminal, configured to receive the carrier object from the first client terminal, and parse the carrier object to obtain relevant information of the hidden information, and obtain valid identification information according to feedback information fed back by a third client terminal; and the third client terminal, configured to receive the relevant information from the second client terminal, and send the feedback information to the second client terminal according to the relevant information.

### Clause 2

The communication system according to clause 1, wherein the first client terminal is further configured to obtain the hidden information in the following manner: receiving, by the first client terminal, original information of the hidden information from the third client terminal; and performing information hiding processing on the original information to obtain the hidden information.

### Clause 3

The communication system according to clause 1, wherein the first client terminal, the second client terminal, and the third client terminal are applications running on the same device or different devices.

### Clause 4

A communication system, comprising: a first device and a second device, the first device running a first application and a second application, and the second device running a third application and a fourth application; the first application, configured to generate a carrier object carrying hidden information; the second application, configured to issue the carrier object; the third application, configured to obtain the carrier object issued by the second application, and obtain valid identification information according to feedback information fed back by the fourth application; and the fourth application, configured to obtain the carrier object from the third application and parse the carrier object to obtain the hidden information when a preset trigger event is detected.

### Clause 5

The communication system according to clause 4, wherein the fourth application is further configured to send the feedback information to the third application based on the carrier object; the third application is further configured to obtain valid identification information based on the feedback information.

### Clause 6

The communication system according to clause 4, wherein the valid identification information includes at least one of the hidden information and the signature information of the carrier object.

### Clause 7

The communication system according to clause 4, wherein the first application and the fourth application are the same application logged in with different accounts running on different devices; wherein the second application and the third application are the same application logged in with different accounts running on different devices.

### Clause 8

The communication system according to clause 4, wherein the preset trigger event includes at least one of detecting that the third application receives the carrier object, detecting an access operation of the carrier object, and detecting that the third application stores the carrier object.

### Clause 9

A communication method, comprising: receiving, by a first client terminal, a carrier object from a second client terminal, wherein the carrier object carries hidden information; parsing, by the first client terminal, the carrier object to obtain relevant information of the hidden information; sending, by the first client terminal, the relevant information to a third client terminal; and receiving, by the first client terminal, feedback information from the third client terminal, and determining valid identification information according to the feedback information, wherein the feedback information is information fed back according to the relevant information.

### Clause 10

The method according to clause 9, wherein the relevant information includes signature information; the feedback information includes a verification result of the signature information; or the relevant information includes two-dimensional code information; the feedback information includes a recognition result of the two-dimensional code information.

### Clause 11

A communication method, comprising: detecting, by a fourth application, a preset trigger event; when the fourth application detects the preset trigger event, obtaining a carrier object from a third application; wherein the carrier object carries hidden information, and the third application obtains the carrier object from content issued by a second application, and the carrier object is generated by a first application; and parsing, by the fourth application, the carrier object to obtain the hidden information.

### Clause 12

The method of clause 11, wherein the method further comprises: sending, by the fourth application, the hidden information to the third application, wherein the third application determines the valid identification information of the carrier object based on the hidden information.

### Clause 13

The method according to clause 11, wherein the first application and the fourth application are the same application logged in with different accounts running on different devices; wherein the second application and the third application are the same application logged in with different accounts running on different devices.

### Clause 14

A storage medium including a stored program, wherein a device in which the storage medium is located performs the following functions when the program is executed: receiving, by a first client terminal, a carrier object from a second client terminal, wherein the carrier object carries hidden information; parsing, by the first client terminal, the carrier object to obtain relevant information of the hidden information; sending, by the first client terminal, the relevant information to a third client terminal; receiving, by the first client terminal, the feedback information from the third client terminal; receiving, by the first client terminal, feedback information from the third client terminal, and determining valid identification information according to the feedback information, wherein the feedback information is information fed back according to the relevant information.

### Clause 15

A processor configured to execute a program, wherein the program performs the following functions when executed: receiving, by a first client terminal, a carrier object from a second client terminal, wherein the carrier object carries hidden information; parsing, by the first client terminal, the carrier object to obtain relevant information of the hidden information; sending, by the first client terminal, the relevant information to a third client terminal; and receiving, by the first client terminal, feedback information from the third client terminal, and determining valid identification information according to the feedback information, wherein the feedback information is information fed back according to the relevant information.

### Clause 16

A data processing method, wherein: detecting a preset trigger event, wherein the preset trigger event includes a save operation on target data performed by the target application; obtaining the target data, wherein the target data includes hidden information; and obtaining the hidden information from the target data, wherein the hidden information includes a target access address or product description information.

### Clause 17

The method according to clause 16 wherein the target data comprises image data, video data, or audio data.

### Clause 18

A data processing method, comprising: detecting a preset trigger event, wherein the preset trigger event includes an opening operation on target data performed by the target application; obtaining the target data, wherein the target data includes hidden information; and obtaining the hidden information from the target data, wherein the hidden information includes a target access address or product description information.

What is claimed is:

1. A system, comprising:
a first client terminal, configured to generate a carrier object carrying hidden information;
a second client terminal, configured to receive the carrier object from the first client terminal, and parse the carrier object to obtain relevant information of the hidden information, and obtain valid identification information according to feedback information fed back by a third client terminal; and
the third client terminal, configured to receive the relevant information from the second client terminal, and send the feedback information to the second client terminal according to the relevant information.

2. The system of claim 1, wherein the first client terminal is further configured to:
receive original information of the hidden information from the third terminal; and
perform information hiding processing on the original information to obtain the hidden information.

3. The system of claim 1, wherein the first client terminal, the second client terminal, and the third client terminal are included in a same device.

4. The system of claim 1, wherein the first client terminal, the second client terminal, and the third client terminal are included in different devices.

5. The system of claim 1, wherein the valid identification information includes at least one of the hidden information and signature information of the carrier object.

6. The system of claim 1, wherein
the relevant information includes signature information; and
the feedback information includes a verification result of the signature information.

7. The system of claim 1, wherein
the relevant information includes two-dimensional code information; and
the feedback information includes a recognition result of the two-dimensional code information.

8. A method, comprising:
receiving, by a first client terminal, a carrier object from a second client terminal, wherein the carrier object carries hidden information;
parsing, by the first client terminal, the carrier object to obtain relevant information of the hidden information;
sending, by the first client terminal, the relevant information to a third client terminal;
receiving, by the first client terminal, feedback information from the third client terminal, and
determining, by the first client terminal, valid identification information according to the feedback information, wherein the feedback information is information fed back according to the relevant information.

9. The method of claim 8, further comprising:
receiving, by the first terminal, original information of the hidden information from the third terminal; and
performing, by the first terminal, information hiding processing on the original information to obtain the hidden information.

10. The method of claim 8, wherein the first client terminal, the second client terminal, and the third client terminal are included in a same device.

11. The method of claim 8, wherein the first client terminal, the second client terminal, and the third client terminal are included in different devices.

12. The method of claim 8, wherein the valid identification information includes at least one of the hidden information and signature information of the carrier object.

13. The method of claim 8, wherein
the relevant information includes signature information; and
the feedback information includes a verification result of the signature information.

14. The method of claim 9, wherein
the relevant information includes two-dimensional code information; and
the feedback information includes a recognition result of the two-dimensional code information.

15. One or more computer-readable media, stored thereon instructions that, when executed by one or more processors, cause the terminal device to perform acts including:
receiving, by a first client terminal, a carrier object from a second client terminal, wherein the carrier object carries hidden information;
parsing, by the first client terminal, the carrier object to obtain relevant information of the hidden information;
sending, by the first client terminal, the relevant information to a third client terminal;
receiving, by the first client terminal, feedback information from the third client terminal, and
determining, by the first client terminal, valid identification information according to the feedback information, wherein the feedback information is information fed back according to the relevant information.

16. The one or more computer-readable media of claim 15, wherein the acts further comprise:
receiving, by the first terminal, original information of the hidden information from the third terminal; and
performing, by the first terminal, information hiding processing on the original information to obtain the hidden information.

17. The one or more computer-readable media of claim 15, wherein the first client terminal, the second client terminal, and the third client terminal are included in a same device.

18. The one or more computer-readable media of claim 15, wherein the first client terminal, the second client terminal, and the third client terminal are included in different devices.

19. The one or more computer-readable media of claim 15, wherein the valid identification information includes at least one of the hidden information and signature information of the carrier object.

20. The one or more computer-readable media of claim 15, wherein
the relevant information includes signature information; and
the feedback information includes a verification result of the signature information.
